(19) United States
(12) Patent Application Publication
(10) Pub. No.: US 2022/0395871 A1
(43) Pub. Date: Dec. 15, 2022

(54) STANDALONE PIGGING SKID

(71) Applicant: Quest Integrity Group, LLC, Sugar Land, TX (US)

(72) Inventor: Maarten Cornelis BURGGRAAFF, Tricht (NL)

(21) Appl. No.: 17/775,495

(22) PCT Filed: Nov. 16, 2020
(86) PCT No.: PCT/US20/60672

§ 371 Date: May 9, 2022

Related U.S. Application Data
(60) Provisional application No. 62/935,826, filed on Nov. 15, 2019.

(51) Int. Cl. B08B 9/055; F16L 55/46

(52) U.S. Cl. CPC B08B 9/0551; F16L 55/46

(57) ABSTRACT

Devices and methods to drive a pig along an interior tube or pipeline are described herein. The pigging unit may be separate from any large trailer to allow for operation of the pigging unit in locations with spatial constraints. The apparatus generally includes a skid, internal components, access points on the exterior of the skid, and a control device.

### CROSS-REFERENCE TO RELATED APPLICATIONS

This application claims priority to U.S. Provisional Patent Application Ser. No. 62/935,826, filed Nov. 15, 2019, entitled “Standalone Pigging Skid,” which is incorporated herein by reference.

### FIELD

This application relates to a pigging skid, specifically a pigging skid for decoking systems.

### BACKGROUND

Pipeline and tubing can become less efficient over time due to exposure to harsh chemicals that can create scale and coke within the pipeline or tubing. This buildup of scale and coke can lead to inefficiencies in the plants and refineries such as reduced process output, higher costs, greater environmental harm and pollutants, and a reduced life of the pipeline or tubing, especially in petrochemical plants and refineries that utilize fired heaters. To avoid these issues and maintain peak efficiency of the plants and refineries, the pipeline or tubing require regular cleaning and monitoring. One method of doing so is mechanical decoking.

Mechanical decoking is the process of passing a device called a pig through tubing or pipelines for cleaning and inspection purposes. The pig is propelled through a pipeline or tubing, and the pig can then execute certain activities inside the pipeline or tubing such as cleaning, inspecting, monitoring, and reporting the conditions within the pipeline or tubing.

One method of propelling the pig through the pipeline or tubing is with a liquid propellant, such as water, cleaning solution, or other product. Sufficient pressure to propel the pig through the pipeline or tubing can be achieved with a liquid circuit comprising a launcher and a receiver attached at opposite ends of the tubing with an external pigging unit to create and control the fluid pressure within the system.

Pigging units typically require large trailers or containers equipped with multiple pumps. The trailers will usually have a water reservoir and control room onboard, and there may be a need for other equipment outside of the trailer taking up even more valuable space. The normal pigging units also require a large amount of space in which to place the trailer and other equipment close enough to the plant's heaters to carry out the decoking process. Plants and refineries with spatial constraints may not always be able to accommodate the usual large pigging units.

Further, some job site locations have specific regulations that don't allow for the use of street space in front of buildings or the use of certain water sources. Normal pigging units may also operate at a higher pressure than needed or utilize more pump units than are strictly necessary for particular job sites. Every job site does not need the same amount of pressure or pump unit capacity. Indeed, some jobs will only need a single pump system to effectively carry out the decoking process. Utilizing inappropriate decoking units thus means that more space is utilized than needed, and plants and refineries can also be left with higher energy costs and a greater environmental toll due to the decoking process.

Prior attempts to solve the above listed problems have been inefficient, forcing the burdened plants and refineries to compromise efficiency and safety or to forego mechanical decoking processes altogether. However, mechanical decoking remains a highly efficient method of cleaning and inspecting the interior of pipeline and tubing, and various spatial and regulatory constraints do not negate the need for regular maintenance of these systems.

Therefore, a need exists for a pigging unit that may stand separate from a large trailer, allowing for locations with spatial constraints to undergo the regular cleaning and monitoring necessary to maintain the safe and efficient functioning of the plant or refinery.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

Devices and methods to a standalone pigging skid are described herein. Embodiments may include internal components; a plurality of access points on the exterior of the skid; and a control device.

One or more embodiments may include the device of the preceding paragraph, wherein the internal components comprise a single pump system with a pressure control valve accessible through at least one of the access points.

One or more embodiments may include the device of any preceding paragraph, wherein the internal components comprise a single pump system with a flow control valve accessible through at least one of the access points.

One or more embodiments may include the device of any preceding paragraph, wherein the control device is remote and wireless.

Devices and methods for an apparatus that drive a pig along an interior tube or pipeline are described herein. Embodiments may include an external shell with a plurality of access points; internal components; and a base capable of housing an onboard energy source.

One or more embodiments may include the apparatus of any preceding paragraph, wherein the internal components comprise a single pump system and at least one connection to a liquid source.

One or more embodiments may include the apparatus of any preceding paragraph wherein the plurality of access points comprise an intake for clean water, an outlet to a pump swivel, and an outlet to a flow control valve.

Methods of forming an apparatus for driving a pig along an interior tube or pipeline are described herein. Embodiments may include providing a plurality of prefabricated internal components; providing a skid with a plurality of internal structures capable of housing the prefabricated internal components; and installing the prefabricated internal components within the skid.

One or more embodiments may include the method of any preceding paragraph, wherein the internal components are a single pump system and an energy source.

### BRIEF DESCRIPTION OF DRAWINGS

Certain embodiments of the disclosure will hereafter be described with reference to the accompanying drawings, wherein like reference numerals denote like elements. It is emphasized that, in accordance with standard practices in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein.

FIG. 1 illustrates a top perspective view of an embodiment of the present disclosure when assembled.

FIG. 2 illustrates a top perspective exploded view of an embodiment of the present disclosure demonstrating the arrangement of the external shell, internal pump components, and base.

FIG. 3 illustrates a side exploded view of an embodiment of the present disclosure with an onboard energy source.

FIG. 4 illustrates a front exploded view of an embodiment of the present disclosure demonstrating various openings on the external shell.

FIG. 5 illustrates a top perspective view of an embodiment of the present disclosure interacting with a remote control device.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions, or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

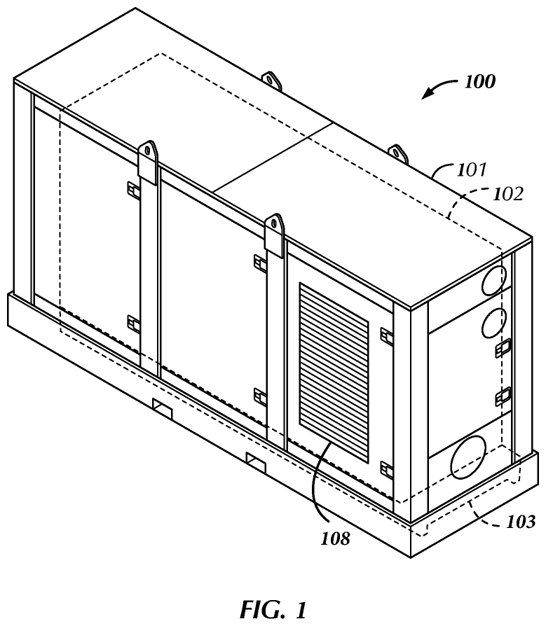

FIG. 1 illustrates a top perspective view of an embodiment of the present disclosure with selected internal components 102 mounted on a base 103. In this embodiment, a standalone pigging skid 100 is represented as having three distinct parts: a base 103, an external shell 101, and internal components 102 atop the base 103 and within the external shell 101. There are also various internal structures that support or simply dictate where the internal components 102 may be installed.

While certain embodiments may be described in terms of these three distinct parts, this is for description purposes only. The various parts may be welded together or separable. For example, the base and external shell may be welded together, and thus not separable. The internal components may also be welded or demountable from the entire skid 100. For purposes of this application, demountable should be understood by those having ordinary skill in the art to mean removable from its setting.

The external shell 101 has various openings, doors, and access holes to access the internal components 102, or to simply protect the internal components 102 or lessen the noise created by the internal components 102 when a mechanical decoking process is being run. A vent 108 is present on the external shell 101 to allow air to escape during operation. The skid 100 does not require mounting within a large trailer or container. Rather, it may be transported and function as a standalone pigging unit.

For job sites with limited access, such as those with restrictions against street use, other spatial constraints, or that only require one pump the standalone pigging unit 100 provides a solution to allow these locations to still undergo necessary mechanical decoking and pigging operations. Rather than using a larger container, the standalone pigging unit 100 may be used as it requires much less space to carry out a mechanical decoking operation. This negates the need to bring a larger container that is equipped with more pumps than necessary for a smaller job.

The driver, controller, or power supply, for the standalone pigging skid 100 can be separated from the standalone pigging skid 100. In certain embodiments, this driver can be an external engine or motor (not shown). In other embodiments, the driver can be one of the internal components 102 disposed within the skid 100.

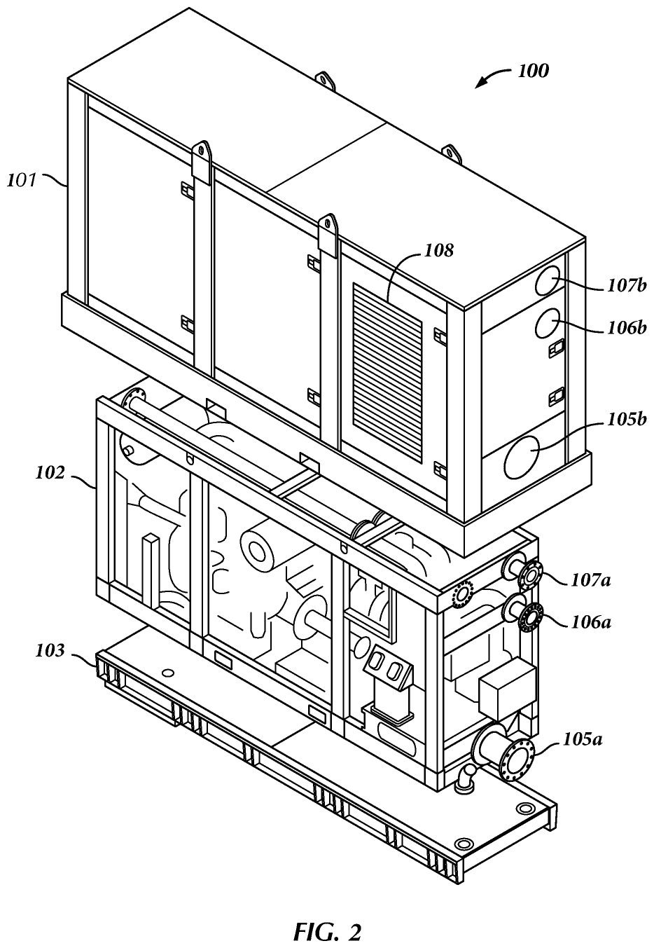

FIG. 2 illustrates a top perspective exploded view of an embodiment of the present disclosure demonstrating the arrangement of the external shell 101, internal pump components 102, and base 103. The external shell 101 is not completely enclosed. Rather, the internal components 102 may be accessed while within the skid 100 using various access points such as openings, windows, doors, and holes built into the external shell 101. These access points are customized based upon the internal components 102 that will be installed within the skid 100. In one embodiment, these access points could include a vent 108, an opening for fluid, such as water, intake 105b, an opening for the fluid outlet 106b, and an opening for the swivel 107b. The openings (105b, 106b, 107b) on the external shell 101 allow for easy accessibility to the internal components 102.

The internal components 102 may be prefabricated, meaning they can be manufactured individually and then later installed within the skid 100. Manufacturing the internal components 102 in this manner allows a manufacturer to work ahead and make various modules in anticipation of future orders. The manufacturer may also outsource many of the manufacturing activities or have them take place side-by-side, thus greatly reducing overall manufacturing times.

The internal components 102 shown here are for a single pump system to perform the decoking process. This embodiment also includes a water intake 105a, a pressure control valve 106a, and a pump swivel 107a. The water intake 105a is connected to an external water source and introduces clean water into the pigging system when the apparatus is in the engaged and operating state. The water intake 105a has a complementary water intake opening 105b on the external shell 101. The pressure control valve 106a has a complementary pressure relief valve opening 106b on the external shell 101. The pump swivel 107a has a complementary opening 107b on the external shell 101. In certain other embodiments, a flow control valve may be installed within the system in addition to or in replacement of the pressure control valve.

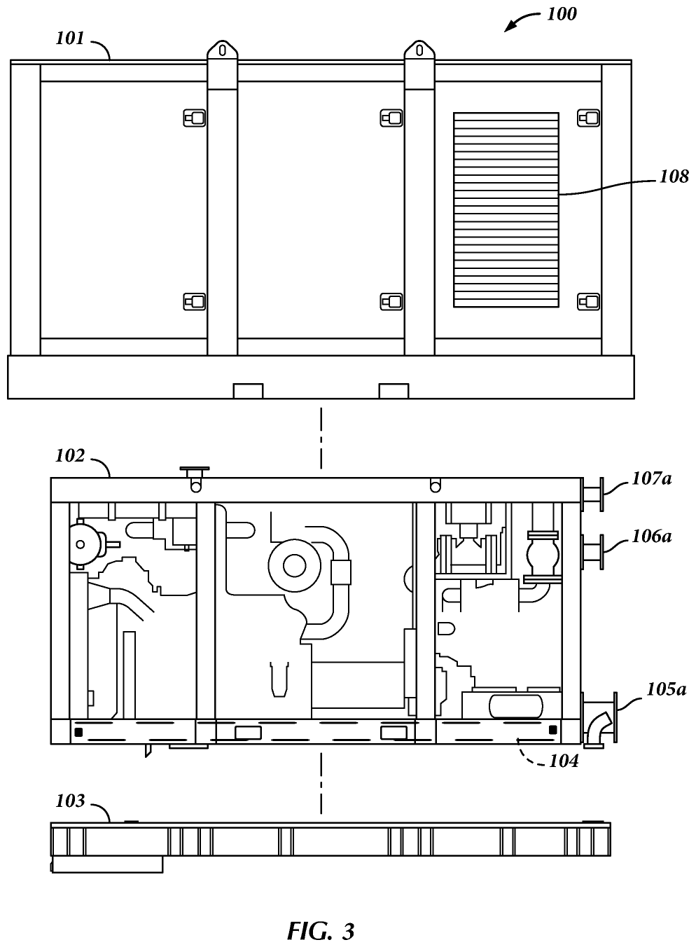

FIG. 3 illustrates a side exploded view of an embodiment of the present disclosure with an onboard energy source 104. The energy source 104 is shown installed beneath the internal components 102 to further the goal of a smaller pigging apparatus for decoking processes. This energy source can be an onboard fuel tank. However, in other embodiments the energy source may include but is not limited to onboard fuel tanks, metal fuel tanks, integral fuel tanks, rigid removable fuel tanks, bladder fuel tanks, or renewable energy sources.

The energy source 104 is shown in this embodiment as spanning the length of the entire internal components. However, depending on the energy demands and arrangement of other internal components, the onboard energy source 104 could be smaller than the length of the entire internal components. The specific arrangement of internal components dictates the ultimate placement and functionality of the onboard energy source 104.

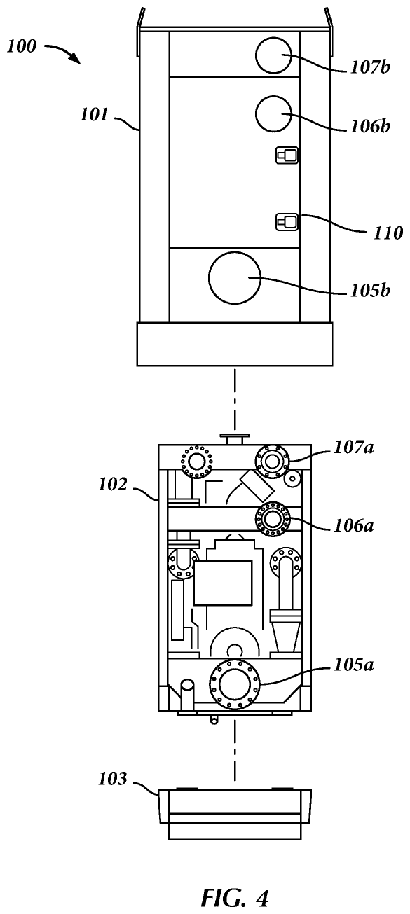

FIG. 4 illustrates a front exploded view of an embodiment of the present disclosure further demonstrating various openings (105b, 106b, 107b) on the external shell 101. Hinges 110 on the external shell 101 show where additional access points may be placed on the external shell 101. Here, a closed access door is shown that can allow further access to the internal components 102.

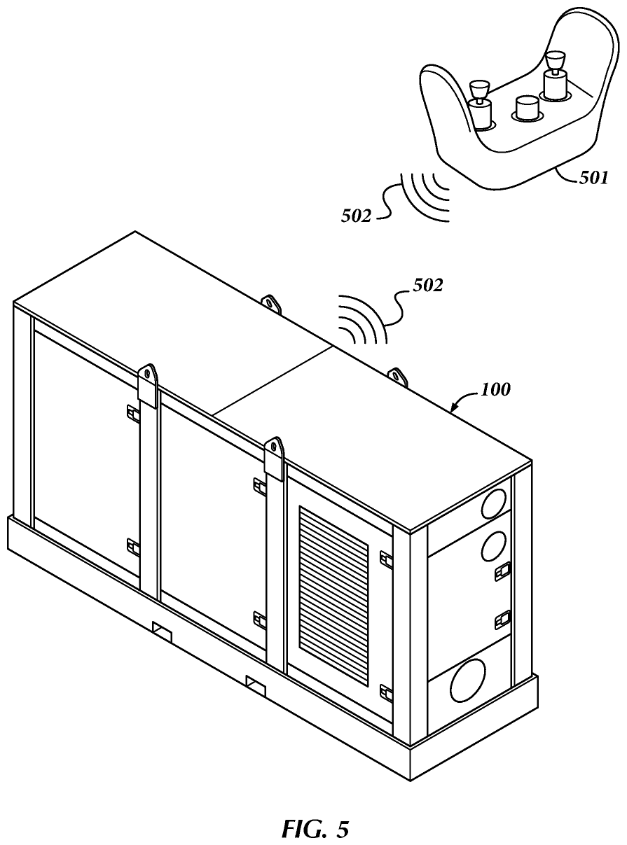

FIG. 5 illustrates a top perspective view of an embodiment of the present disclosure interacting with a control device 501. In a preferred embodiment, the internal components 102 are controlled by a remote and wireless control device 501 transmitting signals 502 to the unit. As shown in this FIG. 5, the signals 502 may be incoming instructions from the control device 501 and external feedback from the system itself transmitted to a user interface. In certain other embodiments, other methods of controlling the system may be used, including but not limited to controls built directly into each part of the internal components 102, wired control systems, or manual control systems.

While various devices and methods have been described above in connection with several illustrative embodiments, it is to be understood that other similar embodiments may be used or modified, and additions may be made to the described embodiments for performing the same function disclosed herein without deviating therefrom.

Further, all embodiments disclosed are not necessarily in the alternative, as various embodiments may be combined or subtracted to provide the desired characteristics. Variations can be made by one having ordinary skill in the art without departing from the spirit and scope hereof. The scope of the present disclosure is determined by the claims that follow.

What is claimed is:

1. A standalone pigging skid comprising:
internal components;
a plurality of access points on exterior surfaces of the skid; and
a control device.

2. The standalone pigging skid of claim 1, wherein the internal components comprise a single pump system with a pressure control valve accessible through at least one of the access points.

3. The standalone pigging skid of claim 1, wherein the internal components comprise a single pump system with a flow control valve accessible through at least one of the access points.

4. The standalone pigging skid of claim 1, wherein the internal components comprise a single pump system and an onboard energy source.

5. The standalone pigging skid of claim 1, wherein the control device is remote and wireless.

6. An apparatus for driving a pig along an interior tube or pipeline comprising:
an external shell with a plurality of access points;
internal components; and
a base capable of housing an onboard energy source.

7. The apparatus of claim 6, wherein the internal components comprise a single pump system and at least one connection to a liquid source.

8. The apparatus of claim 6, wherein the plurality of access points comprise an intake for clean water, an outlet to a pump swivel, and an outlet to a flow control valve.

9. A method of forming an apparatus for driving a pig along an interior tube or pipeline comprising:
providing a plurality of prefabricated internal components;
providing a skid with a plurality of internal structures capable of housing the prefabricated internal components; and
installing the prefabricated internal components within the skid.

10. The method of claim 9, wherein the prefabricated internal components are a single pump system and an energy source.
